(19) United States
(12) Patent Application Publication
(10) Pub. No.: US 2009/0219441 A1
(43) Pub. Date: Sep. 3, 2009

(54) INFORMATION PROCESSING APPARATUS

(75) Inventor: Yukihiro KURITA, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/324,705

(22) Filed: Nov. 26, 2008

(30) Foreign Application Priority Data
Feb. 28, 2008 (JP) 2008-048646

(51) Int. Cl. H04N 5/14

(52) U.S. Cl. 348/571; 348/E05.062

(57) ABSTRACT

According to one embodiment, an information processing apparatus includes: a decoder configured to decode video data to generate a video signal; an adjusting unit configured to execute an adjustment processing on the video signal; an input-output terminal configured to output to an external apparatus the video signal subjected to the adjustment processing by the adjusting unit and to receive identifying information from the external apparatus; and a switching unit configured to select the adjustment processing according to the identifying information.

### CROSS-REFERENCE TO RELATED APPLICATIONS

This application is based upon and claims the benefit of priority from Japanese Patent Application No. 2008-048646, filed Feb. 28, 2008, the entire contents of which are incorporated herein by reference.

### BACKGROUND

1. Field

One embodiment of the invention relates to an information processing apparatus capable of outputting a video signal and an audio signal.

2. Description of the Related Art

In recent years, a personal computer having a function for receiving, seeing and hearing television broadcast program data and reproducing AV (Audio and Visual) contents stored in a DVD (Digital Versatile Disk) has spread widely. Consequently, it is possible to utilize image data during traveling or in a destination by carrying a personal computer of a notebook type which can be driven with a battery, for example.

Recently, a definition of a video has been enhanced and a personal computer capable of reproducing HD (High Definition) image data has also spread, for example. In some cases, the personal computer of this type has a function for externally outputting a high definition video signal. For example, therefore, it is also possible to take pleasure in a high definition video reproduced on a high definition television broadcast receiver having a large screen through a high definition television broadcast receiver having a large screen at home.

It is also possible to propose that a picture quality adjustment processing is carried out over a video signal obtained by decoding video data, thereby improving a picture quality (for example, see JP-A-2004-112169). Examples of the picture quality adjustment processing include a sharpness processing and a luminance adjustment.

However, a display characteristic is usually varied every display. Therefore, it is also supposed that a picture quality is deteriorated depending on a display to be an output destination even if a suitable picture quality adjustment for a certain display is set. It is also possible to propose that a user carries out setting on the display side, thereby performing an image adjustment. However, the user is forced to carry out a complicated operation in order to perform the setting to all displays which might execute an output. The problem is particularly remarkable when a display operation is intended for displays as in the case in which an apparatus on a video signal output side (a video data reproducing apparatus) is a personal computer having a high portability. The problem is the same as in an audio processing.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing a utilizing configuration of an information processing apparatus according to an embodiment,

FIG. 2 is an exemplary diagram showing a structure of the information processing apparatus according to the embodiment,

FIG. 3 is an exemplary diagram showing an example of parameter set information stored in the information processing apparatus according to the embodiment,

FIG. 4 is an exemplary diagram showing a functional block related to a picture quality adjusting function implemented in the information processing apparatus according to the embodiment, and

FIG. 5 is an exemplary flowchart showing an operating procedure for a picture quality adjusting function control of the information processing apparatus according to the embodiment.

### DETAILED DESCRIPTION

Various embodiments according to the invention will be described hereinafter with reference to the accompanying drawings. In general, according to one embodiment of the invention, there is provided an information processing apparatus including: a decoder configured to decode video data to generate a video signal; an adjusting unit configured to execute an adjustment processing on the video signal; an input-output terminal configured to output to an external apparatus the video signal subjected to the adjustment processing by the adjusting unit and to receive identifying information from the external apparatus; and a switching unit configured to select the adjustment processing according to the identifying information.

According to another embodiment of the invention, there is provided an information processing apparatus including: a decoder configured to decode video data to generate a video signal; an adjusting unit configured to execute a first adjustment processing and a second adjustment processing on the video signal; an input-output terminal configured to output to an external apparatus the video signal processed by the adjusting unit and to receive identifying information from the external apparatus; and wherein the adjusting unit execute the first adjustment processing when the input-output terminal receives a first identifying information, and wherein the adjusting unit executes the second adjustment processing when the input-output terminal receives a second identifying information.

According to another embodiment of the invention, there is provided an information processing apparatus including: a decoder configured to decode audio data to generate a audio signal; an adjusting unit configured to execute an adjustment processing on the audio signal; an input-output terminal configured to output to an external apparatus the audio signal subjected to the adjustment processing by the adjusting unit and to receive identifying information from the external apparatus; and a switching unit configured to switch the adjustment processing according to the identifying information.

An information processing apparatus according to the invention will be described below with reference to the drawings.

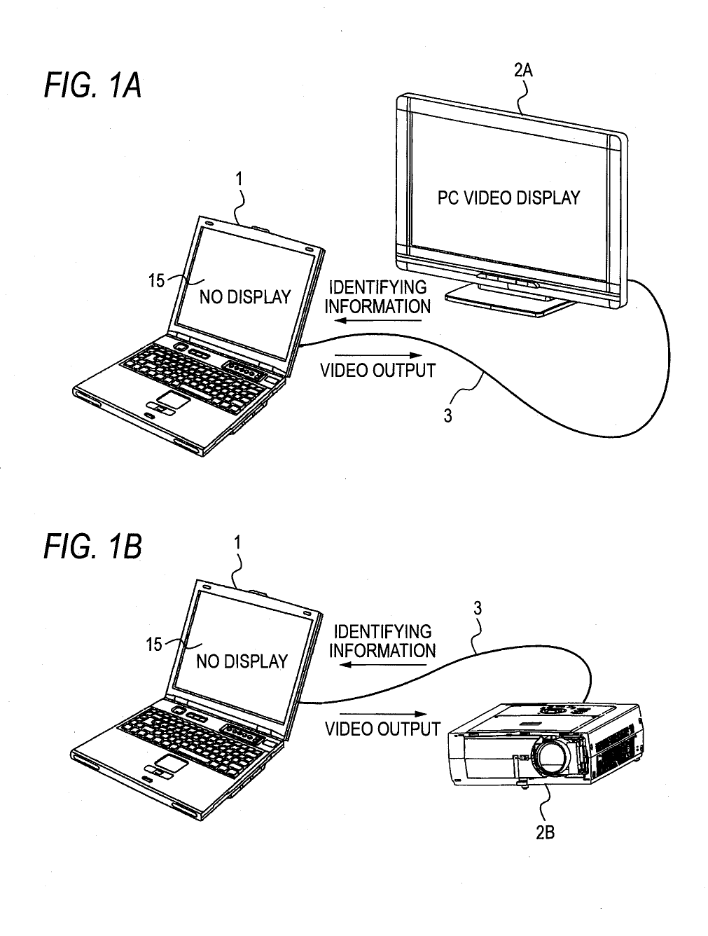

FIGS. 1A and 1B show utilizing configurations of the information processing apparatus according to the embodiment. An information processing apparatus 1 is implemented as a personal computer (PC) of a notebook type, for example. In FIG. 1, an example of a personal computer of a portable type is shown, and a DVD/HDD player (a reproducer) may be employed.

As shown in FIG. 1, it is assumed that the information processing apparatus 1 can be connected to video apparatuses 2A and 2B through a cable 3. In the example of FIG. 1, the video apparatus 2A is a high definition television broadcast receiver having a large screen and the video apparatus 2B is a projector apparatus. In the example, it is assumed that the information processing apparatus 1 is connected to the video apparatuses 2A and 2B through an HDMI (High-Definition Multimedia Interface) cable 3.

Software for reproducing high definition image data (an application program) is variously installed in the information processing apparatus 1, and the connection is carried out through the HDMI cable 3 so that it is possible to take pleasure in a high definition video reproduced by the application program through the video apparatuses 2A and 2B. The information processing apparatus 1 receives unique identifying information assigned to specify an apparatus from the video apparatuses 2A and 2B. In the HDMI standards, EEID can be utilized as identifying information, for example.

It is assumed that the information processing apparatus 1 has a picture quality adjusting function (a picture quality enhancing function) for a video signal. Examples of the picture quality adjustment processing include a brightness correction, a contrast correction, a hue correction, a saturation correction and a gamma correction. A suitable picture quality adjustment processing (more specifically, a suitable parameter) is usually varied depending on a display for displaying a video. Accordingly, the picture quality adjustment processing is switched depending on an output destination of the video signal in the information processing apparatus 1 according to the example.

With reference to FIG. 1, description will be given to an output control of the video signal in the information processing apparatus 1 according to the example. A resource management of the information processing apparatus 1 is unitarily carried out through OS (Operation Soft), and the output destination of the video signal is controlled to be switched through a display driver to be a module in the OS.

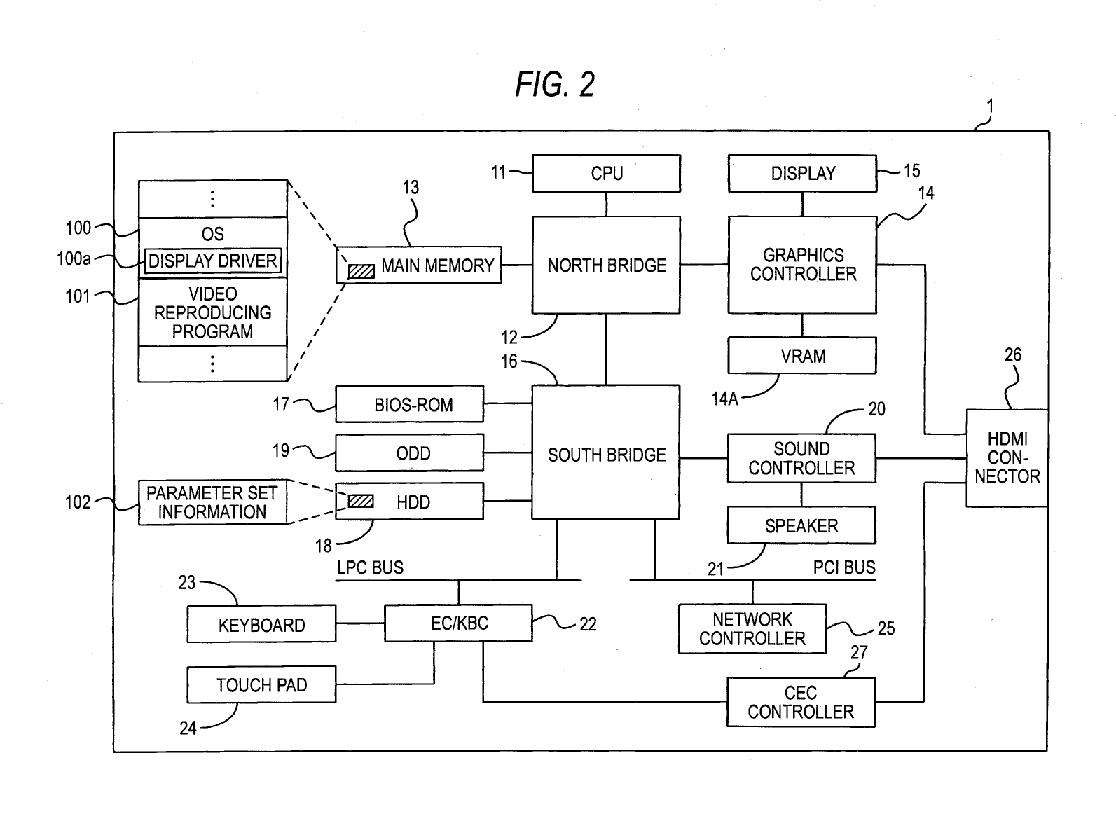

More specifically, description will be given. The output of the video signal is sent to a built-in display 15 such as an LCD and a video is thus displayed through the display driver or is sent to the video apparatus 2A as shown in FIG. 1(a), or both of them are carried out. By changing a connecting destination of the cable 3 as shown in FIG. 1(b), it is also possible to output a video to the video apparatus such as the video apparatus 2B (the projector apparatus in the example of FIG. 2) which is different from the video apparatus 2A (the high definition television broadcast receiver in the example of FIG. 1).

As shown in FIGS. 1(a) and 1(b), the video signal can be output to plural types of video apparatuses. Therefore, the information processing apparatus 1 according to the example acquires identifying information such as EEID from the video apparatus to be the connecting destination and carries out an image adjustment processing corresponding to the identifying information.

In the information processing apparatus 1 according to the example, it is assumed that at least a video signal obtained by reproducing copyrighted digital video data is output to at least one of the built-in display 15 and the HDMI connector when the copyrighted DVD video data are to be reproduced. Consequently, the copyrighting can be carried out more suitably. It is possible to prevent a deterioration in a picture quality related to a video of one of the displays from being caused by outputting a video signal subjected to a picture quality adjustment for the other display to the one of the displays.

While the description will be given by taking, as an example, the case in which the HDMI cable is used as the cable 3 in the example, it is also possible to utilize a DVI cable in place of the HDMI cable if the cable can transmit a video signal and can carry out a communication of identifying information, for instance. Also in the case in which the DVI cable is used, EDID can be utilized as the identifying information in the same manner as in the HDMI, for example.

The identifying information is not restricted to the EDID but ID acquired through COPP (Certified Output Protection Protocol) may be utilized, for example.

FIG. 2 is a diagram showing a structure of the information processing apparatus 1. As shown in FIG. 2, the information processing apparatus 1 includes a CPU 11, a north bridge 12, a main memory 13, a graphics controller 14, a VRAM 14A, a display 15, a south bridge 16, a BIOS-ROM 17, an HDD 18, an optical disk driving device (ODD) 19, a sound controller 20, a speaker 21, an embedded controller/keyboard controller (EC/KBC) 22, a keyboard 23, a touch pad 24, a network controller 25, an HDMI connector 26, and a CEC (Consumer Electronics Control) controller 27.

The CPU 11 is a processor for controlling an operation of each portion in the information processing apparatus 1. The CPU 11 executes an operating system (OS) 100 loaded onto the main memory 13 from the HDD 18 and an application which is operated under control of the OS 100 and serves to handle a utility and AV contents data (for example, a video reproducing program 101). The CPU 11 also executes a basic input/output system (BIOS) stored in the BIOS-ROM 17. The basic input/output system itself stored in the BIOS-ROM 17 will be hereinafter referred to as the BIOS 17 in some cases.

The north bridge 12 is a bridge device for connecting a local bus of the CPU 11 to the south bridge 16. The north bridge 12 has a function for executing a communication with the graphics controller 14 through a bus and also includes a memory controller for access controlling the main memory 13. The graphics controller 14 is a display controller for controlling the display 15 on the information processing apparatus 1 side. The graphics controller 14 generates a video signal to be transmitted to the display 15 from image data written to the VRAM 14A. The graphics controller 14 also has a function for externally outputting the video signal to the HDMI connector 26.

The south bridge 16 is a controller for controlling various devices provided on a PCI bus and an LPC bus. The BIOS-ROM 17, the HDD 18, the ODD 19 and the sound controller 20 are directly connected to the south bridge 16, and the south bridge 16 also has a function for controlling them. The HDD 18 stores television broadcast program data and AV contents downloaded via internet, for example, and the ODD 19 accommodates a DVD storing the AV contents data, for example. The sound controller 20 is a sound source controller for controlling the speaker 21. The sound controller 20 also has a function for externally outputting an audio signal from the HDMI connector 26.

The HDD 18 stores parameter set information 102 of a parameter to be used in an execution of a picture quality adjustment processing through the video reproducing program 101. This is stored by setting a suitable parameter through a user when outputting a video signal, for example. The parameter sets are set/stored every video apparatus to be an output destination.

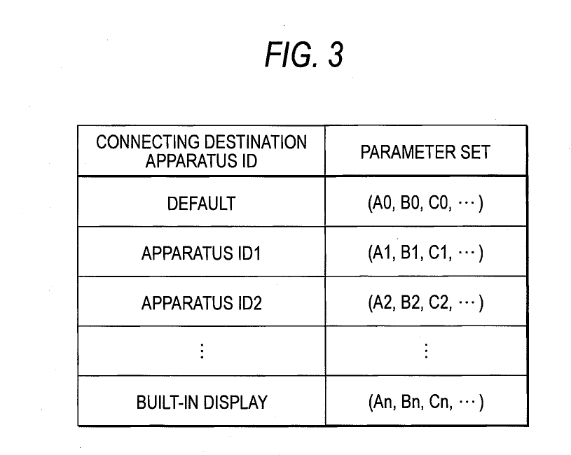

FIG. 3 shows an example of the parameter set information 102. In the example of FIG. 3, an ID of the video apparatus to be the output destination (which corresponds to an apparatus ID1 or an apparatus ID2) and a corresponding parameter set (a combination of at least one of parameters A1, B1 and C1) are caused to make a pair. The video reproducing program 101 carries out the picture quality adjustment processing by utilizing the parameter set corresponding to received identifying information with reference to the parameter set information 102.

Examples of the information about the parameters included in the parameter set information 102 include set values of a brightness, a contrast, a hue, a saturation and a gamma.

In the example of FIG. 3, the parameter set information also includes a parameter set of a default (A0, B0, C0, . . . ). This is the parameter set to be utilized in an output of a video signal to a video apparatus to which a suitable parameter set for a user has not been designated.

In the example of FIG. 3, a parameter set for the built-in display 15 is also included in the parameter set information.

While description will be given on the assumption that the user sets the parameter set in the example, this is not restricted but the parameter set may be preset in a shipment. However, a more flexible action can be carried out when the user can perform a customization. In addition, it is not necessary for the user to carry out a reset every output.

Although the parameter set is simply prepared corresponding to only the video apparatus (identifying information) to be a video output destination in the example of FIG. 3, this is not restricted but the parameter set may also correspond to video data to be reproduced, for example. For instance, it is possible to propose the case in which a parameter set to be used in an output of a video obtained by reproducing video data of a specific DVD to a video apparatus having the apparatus ID1 is stored as the parameter set information 102 in the HDD 18.

Returning to the description of FIG. 2, the EC/kBC 22 is a one-chip microcomputer in which an embedded controller for a power management and a keyboard controller for controlling the keyboard 23 and the touch pad 24 are integrated. The EC/KBC 22 is also operated during power-OFF of the information processing apparatus 1 and monitors whether a power-ON operation is carried out or not, and executes a control for starting the information processing apparatus 1 when an event to be turned ON is generated, for example. The EC/KBC 22 also executes a power supply to the CEC controller 27 continuously during power-OFF of the information processing apparatus 1.

The network controller 25 is a communicating device for executing a communication with an external network such as internet.

The HDMI connector 26 is a terminal which is provided for removably connecting the HDMI cable 3. The CEC controller 27 executes a data transfer control for transmitting and receiving various commands (control signals) for an operation control through the HDMI connector 26 under control of the EC/KBC 22. The commands to be transmitted and received include a power-ON request command to be received by the CEC controller 27, for example. EDID to be identifying information for identifying the video apparatus 2A or 2B is also received by the HDMI connector 26.

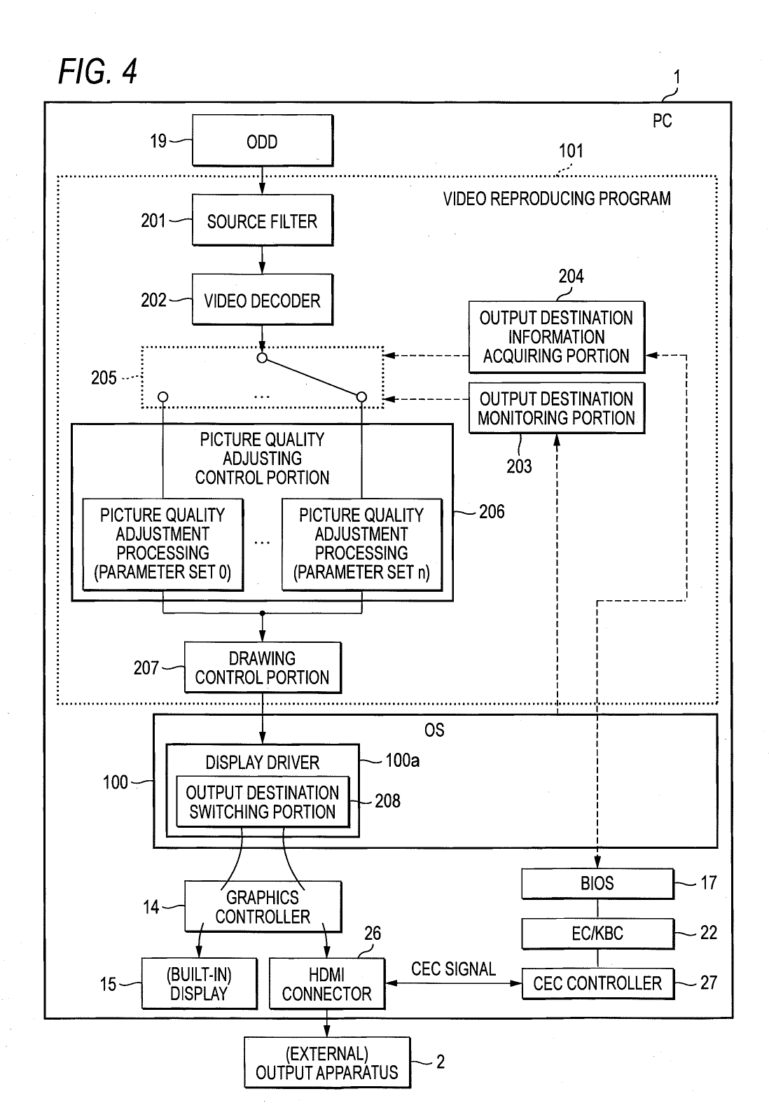

FIG. 4 is a diagram showing a functional block related to a video data reproducing and image adjusting function which is implemented in the information processing apparatus 1 having the structure. Description will be given on the assumption that the video reproducing program 101 is an application program for reproducing video data read from an optical disk through the ODD. However, it is sufficient that the video reproducing program 101 is a program for reproducing a video signal from video data. For example, the video reproducing program 101 may be a program for reproducing a TV broadcast received through a tuner, a program for reproducing an IPTV broadcast received through an IP network or a program for reproducing video data recorded onto an HDD.

For example, the video data read from the optical disk through the ODD 19 are decoded into a video signal by a decoding portion (a video decoder) 202 under control of a data reading portion (a source filter) 201.

An output destination monitoring portion 203 detects whether an output destination switching portion 208 of a display driver 100a is set to output the video signal to the HDMI connector 26 or the display 15. More specifically, there is proposed a method of periodically calling (through polling) an API (Application Program Interface) for inquiring an output destination of the video signal which is provided by the OS 100 when or after starting the video reproducing program 101, for example. Alternatively, it is also possible to previously request the OS 100 in order to give a notice of a generation of an event for output destination switching, for example.

An output destination information acquiring portion 204 acquires identifying information (for example, EDID) of the video apparatus 2 (an external display) connected to the HDMI connector 26 through the HDMI cable 3 when an output destination for the video signal is set to be the HDMI connector 26. The information is led as a control signal (a CEC signal) into the information processing apparatus 1 through the HDMI connector 26, for example, and is received by the CEC controller 27 so that a notice of the receipt of the control signal is given to the EC/KBC 22. Upon receipt of the notice, the EC/KBC 22 generates a key code which indicates the contents of the notice (identifying information about the video apparatus 2, and information about a type name and a manufacturer name may be included, for example) as data to be input to the output destination information acquiring portion 204. The key code is transferred to the OS 100 through the BIOS 17, and furthermore, is transferred from the OS 100 to the output destination information acquiring portion 204.

An adjustment switching portion 205 switches a picture quality adjusting function for an output of the video signal decoded by the decoding portion 202 depending on an output destination of the video signal which is acquired by the output destination monitoring portion 203 and a type of the video apparatus 2 which is acquired by the output destination information acquiring portion 204 when the video signal is output to the HDMI connector 26. More specifically, the adjustment switching portion 205 refers to the parameter set information 102 stored in the HDD 18, thereby switching which parameter set is to be used by a picture quality adjusting control portion 206 depending on the output destination of the video signal, a parameter set adjusted corresponding to the built-in display 15, a parameter set adjusted for the video apparatus 2A, a parameter set adjusted for the video apparatus 2B or a parameter set of a default value (a parameter set for a video apparatus to which a parameter is not set), for example.

Consequently, also in the case in which an output to the built-in display 15 is carried out and the case in which the video signal is output from the HDMI connector 26, it is possible to output a video signal having a picture quality adjusted in a parameter which is optimized depending on an output destination. Thus, it is possible to improve a picture quality of an output video. Since an initial value is prepared, it is possible to carry out a picture quality adjustment processing using a parameter set based on the initial value even if a video signal is output to a video apparatus to be connected for the first time. Therefore, it is possible to expect the improvement in the picture quality more greatly as compared with the case in which any processing is not carried out.

The picture quality adjusting control portion 206 carries out a picture quality adjustment processing in a picture quality adjusting parameter set selected by the adjustment switching portion 205 for the video signal decoded by the decoding portion 202. The picture quality adjustment processing includes processings of correcting a brightness, a contrast, a hue, a saturation and a gamma (and a combination of the processings), for example.

A drawing control portion 207 executes a rendering processing for writing an image to the VRAM 14A from a video signal subjected to the picture quality adjustment through the picture quality adjusting control portion 206.

The display driver 100a controls a driving operation of the graphics controller 14 under control of the OS 100. The display driver 100a has the output destination switching portion 208 for switching the output destination of the video signal. The display driver 100a switches the output destination of the video signal of an image output from the drawing control portion 207 (which is temporarily stored in the VRAM 14A) into either the built-in display 15 or the HDMI connector 26 through the output destination switching portion 208.

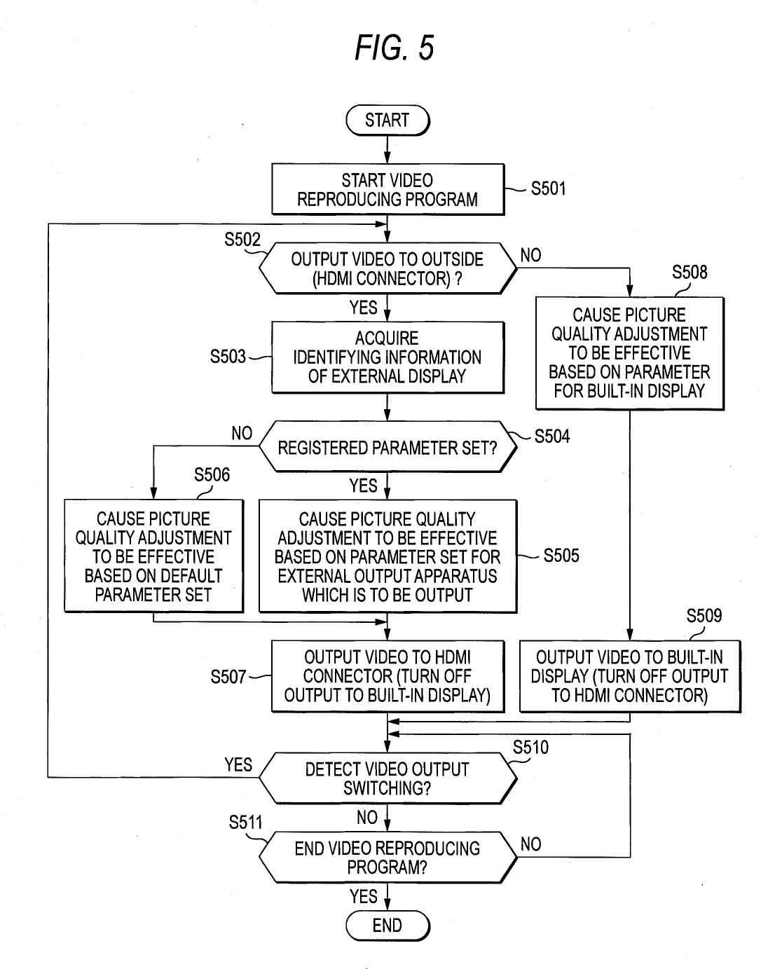

FIG. 5 is a flowchart showing an operating procedure for a picture quality adjusting function control of the video reproducing program 101 which is to be executed by the information processing apparatus 1 according to the example.

When the video reproducing program 101 is started (S501), the output destination monitoring portion 203 inquires of the OS 100 about the built-in display 15 or the HDMI connector 26 to which an output destination of a video signal is set (S502). If the output destination is the HDMI connector 26 (Yes in S502), the output destination information acquiring portion 204 acquires identifying information of the video apparatus 2 connected to the HDMI connector 26 (S503).

The adjustment switching portion 205 confirms whether or not a parameter set corresponding to the acquired identifying information is registered as the parameter set information 102 (S504). If the parameter set is registered (Yes in S504), the picture quality adjusting control portion 206 carries out a picture quality adjustment processing based on the parameter set (S505). If the parameter set corresponding to the acquired identifying information is not registered in the parameter set information 102 (No in S504), the picture quality adjusting control portion 206 carries out a picture quality adjustment processing based on a parameter set of a default (S506). In the case in which the parameter set is not defined (the parameter set of the default is used), it is also possible to create a message indicating that a suitable parameter set has not been set and to output the message as a video/ voice.

The display driver 100a outputs, to the HDMI connector 26, a video signal subjected to the video adjustment processing through the picture quality adjusting control portion 206 (S507). At this time, a video signal (a video signal obtained by reproducing copyrighted digital video data) is not output to the built-in display 15 in the example.

On the other hand, if the output destination is the built-in display 15 at the S502 (No in S502), the adjustment switching portion 205 selects a picture quality adjusting parameter set which is adjusted corresponding to the built-in display 15 and the picture quality adjusting control portion 206 carries out a picture quality adjustment processing based on the parameter set (S508). The display driver 100a outputs, to the built-in display 15, a video signal subjected to the picture quality adjustment processing (S509). At this time, the video signal (the video signal obtained by reproducing copyrighted digital video data) is not output to the HDMI connector 26 in the example.

When the output destination monitoring portion 203 detects that the output destination of the video signal is changed after a start of the output of the video signal at the S507 or S509 (Yes in S510), the processing returns to the S502 in which the picture quality adjustment processing is switched.

If the output destination of the video signal is not switched (No in S510) and the video reproducing program 101 is not ended (No in S511), the output destination monitoring portion 203 continuously monitors the output destination of the video signal at the S510.

As described above, according to the example, the picture quality adjustment processing is switched depending on whether the output destination of the video signal is the built-in display 15 or the HDMI connector 26 and depending on a type of the video apparatus 2 when the output destination is the HDMI connector 26. Consequently, it is possible to display a video subjected to the picture quality improvement through the picture quality adjustment processing which carries out an adjustment suitably for the built-in display or each of the video apparatuses 2.

While the video data/video signal processing has been described in the example, a voice data/audio signal processing can be executed in the same manner.

As described with reference to the embodiment, there is provided an information processing apparatus capable of suitably switching a picture quality adjustment and a sound quality adjustment.

According to the embodiment, it is possible to provide an information processing apparatus capable of suitably switching a picture quality adjustment and a sound quality adjustment.

What is claimed is:

1. An information processing apparatus comprising:
a decoder configured to decode video data and to generate a video signal;
an adjusting module configured to execute an adjustment on the video signal;
a terminal configured to output the adjusted video signal to an external apparatus and to receive an identifying information from the external apparatus; and
a switching module configured to select the adjustment according to the received identifying information.

2. The information processing apparatus of claim 1, further comprising a storage module configured to store a plurality of parameter sets for the adjustment, the plurality of parameter sets being associated with a plurality of identifying informations,
wherein the switching module is configured to select a parameter set corresponding to the received identifying information for the adjustment.

3. The apparatus of claim 2, wherein the plurality of parameter sets comprises an initial parameter set, and
wherein the switching module is configured to select the initial parameter set for the adjustment when the plurality of parameter sets do not comprise a parameter set corresponding to the received identifying information.

4. The apparatus of claim 2, further comprising:
a display; and
a display driver configured to control a video signal output to the display and the terminal,
wherein the plurality of parameter sets comprises a display parameter set for the display, and
wherein the switching module is configured to select the display parameter set for the adjustment when the video signal is output to the display.

5. The information processing apparatus of claim 2 further comprising a detecting module configured to detect an output destination of the video signal; and
a receiver configured to receive the identifying information from the external apparatus through the terminal when the detecting module detects that the output destination has changed.

6. An information processing apparatus comprising:
a decoder configured to decode video data and to generate a video signal;
an adjusting module configured to execute a first adjustment and a second adjustment on the video signal;
a terminal configured to output the adjusted video signal to an external apparatus and to receive identifying information from the external apparatus; and
wherein the adjusting module is configured to execute the first adjustment when the terminal receives a first identifying information, and
wherein the adjusting module is configured to execute the second adjustment when the terminal receives a second identifying information.

7. The apparatus of claim 6, wherein the adjusting module is configured to execute the first adjustment when the terminal receives a third identifying information.

8. An information processing apparatus comprising:
a decoder configured to decode audio data and to generate a audio signal;
an adjusting module configured to execute an adjustment on the audio signal;
a terminal configured to output the adjusted audio signal to an external apparatus and to receive an identifying information from the external apparatus; and
a switching module configured to switch the adjustment according to the identifying information.

9. The apparatus of claim 8, further comprising a storage module configured to store a plurality of parameter sets for the adjustment, the plurality of parameter sets being associated with a plurality of identifying informations,
wherein the switching module is configured to select a parameter set corresponding to the received identifying information for the adjustment.

10. The apparatus of claim 8, wherein the plurality of parameter sets comprises an initial parameter set, and
wherein the switching module is configured to select the initial parameter set for the adjustment when the plurality of parameter sets does not comprise a parameter set corresponding to the received identifying information.

11. The information processing apparatus of claim 1, wherein the terminal comprises a connector configured to connect to a cable.

12. The information processing apparatus of claim 6, wherein the terminal comprises a connector configured to connect to a cable.

13. The information processing apparatus of claim 8, wherein the terminal comprises a connector configured to connect to a cable.
